(19) United States
(12) Patent Application Publication
(10) Pub. No.: US 2025/0053942 A1
(43) Pub. Date: Feb. 13, 2025

(54) SYSTEM FOR PROVIDING FINANCIAL TRANSACTION SERVICES IN CONJUNCTION WITH METAVERSE ENVIRONMENT AND METHOD OF OPERATING THE SAME

(71) Applicant: Jong-Myung LEE, Seoul (KR)

(72) Inventor: Jong-Myung LEE, Seoul (KR)

(21) Appl. No.: 18/717,728

(22) PCT Filed: Oct. 11, 2022
(86) PCT No.: PCT/KR2022/015286

§ 371 Date: Jun. 7, 2024

(30) Foreign Application Priority Data
Dec. 10, 2021 (KR) 10-2021-0176631

(51) Int. Cl. G06Q 20/10; G06Q 20/36

(52) U.S. Cl. CPC G06Q 20/1085; G06Q 20/367

(57) ABSTRACT

Various embodiments of the present invention relate to a system for providing financial transaction services in conjunction with a metaverse environment and a method of operating the same. According to various embodiments of the present invention, the present invention may provide financial transaction services that may improve user convenience by providing financial transaction services using an ATM device in the real world and providing financial transaction services using a virtual ATM device within the metaverse environment.

### TECHNICAL FIELD

Various embodiments of the present invention relate to a system for providing financial transaction services in conjunction with a metaverse environment and a method of operating the same.

### BACKGROUND ART

When there was no currency, barter was used, and over time, coins and banknotes were created, and with the gradual development of technology and digitalization, new concepts of currency such as virtual currency emerged. This virtual currency refers to currency that has no substance in a virtual environment, unlike fiat currency (e.g., coins, banknotes) that is actually traded.

Recently, among virtual currencies, a cryptographic virtual currency (hereinafter abbreviated as ‘cryptocurrency’) represented by ‘bitcoin’ has been developed and distributed.

Unlike existing virtual currencies, cryptocurrency operates in a P2P (Peer-to-Peer) manner. In the case of cryptocurrency, when a transaction is completed, a new block that serves as a ledger is created, and the new block is connected to the existing block. In addition, a timestamp is recorded for each new block, and the timestamp serves as information proving the time when the transaction occurred.

In addition, in the case of credit cards or various simple payments, the amount deposited in the bankbook is deducted from a payment account and a cash transaction is actually carried out through account transfer. However, in the case of cryptocurrency, users can buy and sell goods using only cryptocurrency without cash.

In addition, cryptocurrency transactions can be made by exchanging cryptocurrency through networks, Internet, QR codes, etc., and purchasing/selling at cryptocurrency-only ATMs is also possible.

In addition, as activities within the metaverse environment increase, the need for various financial services using cryptocurrency within the metaverse environment is gradually increasing.

### DISCLOSURE

### Technical Problem

Therefore, the present invention has been made in view of the above problems, and it is one object of the present invention to provide a system for providing financial transaction services in conjunction with a metaverse environment and a method of operating the same. The system and method of the present invention may provide financial transaction services for cryptocurrency to be used within a metaverse environment using an ATM device implemented in reality and may provide financial transaction services for real-world fiat currency using a virtual ATM device implemented within the metaverse environment.

### Technical Solution

In accordance with one aspect of the present invention, provided is a system for providing financial transaction services in conjunction with a metaverse environment including an automated teller machine (ATM) device; a metaverse service provision server configured to implement a metaverse environment in which a virtual ATM device operates; and a financial transaction service provision server that processes functions related to electronic financial services supported by the ATM device and the virtual ATM device and is configured to create an electronic wallet and provide the electronic wallet to a user, wherein the financial transaction service provision server is configured to 1-1) determine whether a first electronic wallet is linked to the metaverse service provision server when receiving a first remittance request for the first electronic wallet from the ATM device; 1-2) perform first identity authentication using a face image and identification card image of a first remittance requestor when the first electronic wallet is linked to the metaverse service provision server; 1-3) perform a remittance function to the first electronic wallet using remittance amount information confirmed from the first remittance request when the first identity authentication is passed; 2-1) perform second identity authentication for the first electronic wallet when receiving a first withdrawal request for the first electronic wallet from the ATM device; and 2-2) perform a withdrawal function through the ATM device using withdrawal amount information confirmed from the first withdrawal request when the second identity authentication is passed.

According to various embodiments, when receiving a second remittance request for a second electronic wallet originating from the virtual ATM device from the metaverse service provision server, the financial transaction service provision server may be configured to determine whether a specific currency type corresponding to the second electronic wallet is fiat currency or cryptocurrency.

According to various embodiments, the financial transaction service provision server may be configured to perform third identity authentication for a second remittance requestor when the specific currency type corresponding to the second electronic wallet is the fiat currency; perform fourth identity authentication for a recipient of the second remittance request when the third identity authentication is successful; and perform a remittance function to the second electronic wallet using remittance amount information confirmed from the second remittance request when the fourth identity authentication is successful.

According to various embodiments, when the specific currency type corresponding to the second electronic wallet is the cryptocurrency, the financial transaction service provision server may be configured to omit the third identity authentication and the fourth identity authentication and perform a remittance function to the second electronic wallet.

According to various embodiments, when receiving a second withdrawal request for the second electronic wallet originating from the virtual ATM device from the metaverse service provision server, the financial transaction service provision server may be configured to perform fifth identity authentication for the second electronic wallet.

According to various embodiments, when the fifth identity authentication is passed, the financial transaction service provision server may be configured to perform a withdrawal function through the virtual ATM device using withdrawal amount information confirmed from the second withdrawal request.

### Advantageous Effects

According to various embodiments of the present invention, the present invention can provide financial transaction services that can improve user convenience by providing financial transaction services using an ATM device in the real world and providing financial transaction services using a virtual ATM device within the metaverse environment.

### DESCRIPTION OF DRAWINGS

FIG. 1 illustrates devices constituting a system for providing financial transaction services in conjunction with a metaverse environment according to various embodiments.

FIG. 2 is a flowchart for explaining the operation of a financial transaction service provision server according to various embodiments.

FIG. 3 includes images showing an embodiment in which a QR code for the address of an electronic wallet is scanned by an ATM device.

FIG. 4 is a flowchart for explaining the operation of a financial transaction service provision server according to various embodiments.

FIG. 5 includes images showing the operation of an ATM device according to various embodiments.

### BEST MODE

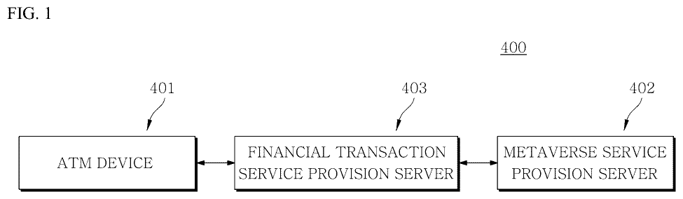

FIG. 1 illustrates devices constituting a system 400 for providing financial transaction services in conjunction with a metaverse environment according to various embodiments of the present invention.

According to various embodiments, the system 400 for providing financial transaction services in conjunction with a metaverse environment may include an automated teller machine (ATM) device 401, a metaverse service provision server 402 configured to implement a metaverse environment in which a virtual ATM device operates, and a financial transaction service provision server 403 configured to process functions related to financial transaction services supported by the ATM device 401 and a virtual ATM device, create an electronic wallet, and provide the electronic wallet to a user.

According to one embodiment, the ATM device 401 may be a device for providing financial transaction services such as payment, remittance, withdrawal, currency exchange, and recharge to users. The ATM device 401 may transmit a request for a financial transaction to the financial transaction service provision server 403, receive a processed result from the financial transaction service provision server 403, and provide a financial transaction service to a user based on the processed result. The ATM device 401 according to the present invention may be designed to not only support financial transactions for general fiat currency (e.g., KRW), but also to support financial transactions for cryptocurrency.

According to one embodiment, the metaverse service provision server 402 may be configured to implement a metaverse environment. Metaverse is a word that combines ‘meta’, meaning virtual and transcendent and ‘universe’ meaning world and universe. The metaverse service provision server 402 may provide services using a three-dimensional virtual space environment where social and economic activities like the real world are common. According to one embodiment, the metaverse service provision server 402 may perform non-face-to-face identity verification to create an avatar. When performing a non-face-to-face identity verification operation, the metaverse service provision server 402 may photograph an identification card (e.g., passport), issue a face ID using a face recognition function using a real-time camera, perform e-mail authentication, and optionally set a PIN number. According to one embodiment, the metaverse service provision server 402 may issue a unique electronic wallet for each user, implement a virtual ATM device in a metaverse environment, and provide a virtual POS device that performs payment functions using a QR code. According to one embodiment, the metaverse service provision server 402 may provide various financial transaction services (e.g., currency exchange, remittance, recharge, deposit/withdrawal, payment) in connection with the financial transaction service provision server 403. According to one embodiment, the metaverse service provision server 402 may issue non-fungible tokens (NFTs) within a metaverse environment.

According to one embodiment, the financial transaction service provision server 403 may provide financial transaction services through the ATM device 401 or may send and receive commands for financial transactions to and from the metaverse service provision server 402 so that financial transaction services are provided by a virtual ATM device in a metaverse environment. The financial transaction service provision server 403 may assign a unique electronic wallet to each user, and the electronic wallet may include a plurality of sub-electronic wallets corresponding to each of a plurality of currencies.

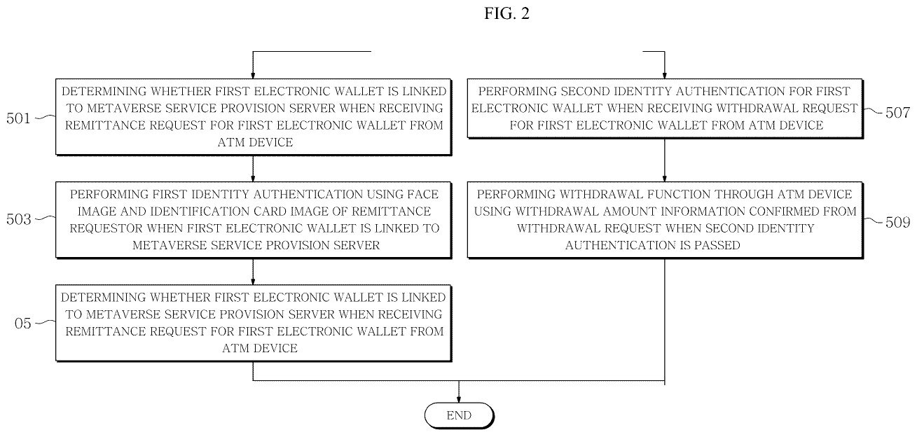

FIG. 2 is a flowchart for explaining the operation of a financial transaction service provision server 403 according to various embodiments.

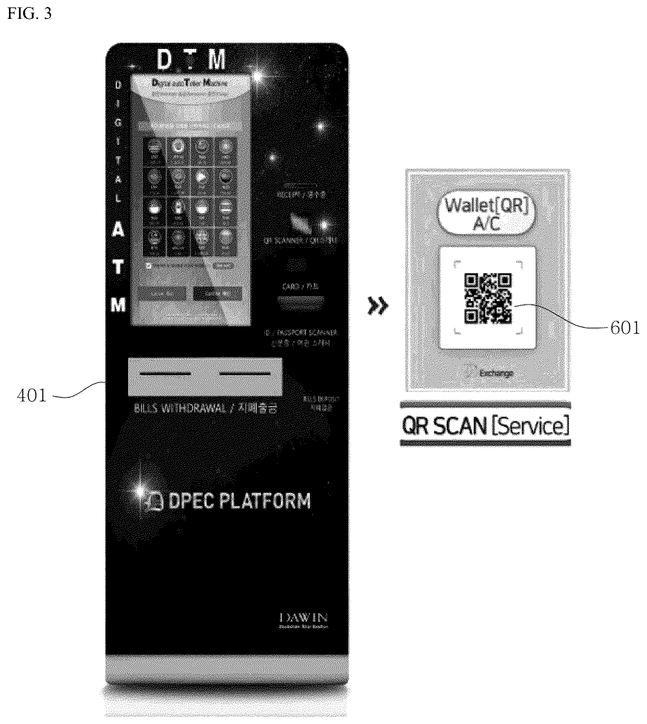

FIG. 3 is a diagram showing an embodiment in which the ATM device 401 scans a QR code related to the address of an electronic wallet, according to various embodiments.

In operation 501, according to various embodiments, when receiving a remittance request for a first electronic wallet from an ATM device (e.g., the ATM device 401 of FIG. 1), the financial transaction service provision server 403 may determine whether the first electronic wallet is linked to a metaverse service provision server (e.g., the metaverse service provision server 402 of FIG. 1). The electronic wallet may be used to store currency (e.g., fiat currency or cryptocurrency).

According to one embodiment, the financial transaction service provision server 403 may check the wallet address of the first electronic wallet included in the remittance request for the first electronic wallet. For example, referring to FIG. 3, the ATM device 401 may recognize a QR code 601 displayed on a user terminal using a camera included in the ATM device 401, and may include the wallet address of the first electronic wallet confirmed from the QR code 601 in the remittance request and send the remittance request to the financial transaction service provision server 403. The financial transaction service provision server 403 may check the wallet address of the first electronic wallet from the remittance request. Alternatively, the ATM device 401 may include the QR code 601 in the remittance request and transmit the remittance request to the financial transaction service provision server 403, and the financial transaction service provision server 403 may check the wallet address of the first electronic wallet by analyzing the QR code 601.

According to one embodiment, the financial transaction service provision server 403 may determine whether the first electronic wallet is linked to the metaverse service provision server 402. For example, when the wallet address of the first electronic wallet is included among wallet addresses previously stored (registered) as a linked wallet in a memory, the financial transaction service provision server 403 may determine that the first electronic wallet is linked to the metaverse service provision server 402. As another example, when the metaverse service provision server 402 is inquired as to whether the wallet address of the first electronic wallet is being used or registered in the metaverse service provision server 402, and a response affirming the inquiry is received, the financial transaction service provision server 403 may determine that the first electronic wallet is linked to the metaverse service provision server 402. Among the electronic wallets provided by the financial transaction service provision server 403, a user may use financial services provided by the financial transaction service provision server 403 through the electronic wallet that is linked to the metaverse service provision server 402. In addition, the user may conveniently use financial services provided within the corresponding metaverse environment.

In operation 503, according to various embodiments, when the first electronic wallet is linked to the metaverse service provision server 402, the financial transaction service provision server 403 may perform first identity authentication using the face image and identification card image of a remittance requestor. For example, the ATM device 401 may photograph the face image of a remittance requestor using a camera, and may scan the identification card image of the remittance requestor using an identification card scanner. The ATM device 401 may transmit the captured face image and the scanned identification card image to the financial transaction service provision server 403. The identification card image may include images of a resident registration card, passport, or driver's license.

According to one embodiment, when the first electronic wallet is linked to the metaverse service provision server 402, the financial transaction service provision server 403 may transmit an initiation request for first identity authentication to the ATM device 401, and may receive the captured face image and the scanned identification card image from the ATM device 401.

According to one embodiment, when the match rate between the captured face image and the scanned face image exceeds a set value by comparing face images in the captured face image and the scanned identification card image, the financial transaction service provision server 403 may determine that the first identity authentication has been passed. When the match rate is below a specified value, the financial transaction service provision server 403 may determine that the first identity authentication failed. According to one embodiment, the financial transaction service provision server 403 may transmit the captured face image and the scanned identification card image to an external server (e.g., National Police Agency server), and may determine whether the first identity authentication has been passed based on the authentication result received from the external server. According to one embodiment, the financial transaction service provision server 403 may determine whether the scanned identification card image has been forged/tampered before performing the first identity authentication. For example, the financial transaction service provision server 403 may perform a validation check on identification information (e.g., resident registration number, license number, issuance date, etc.) extracted from an identification card according to an optical character reader (OCR), perform an infrared inspection that calculates and compares infrared transmission values scanned from an infrared lamp, and perform an ultraviolet light inspection that calculates and compares ultraviolet reflection values scanned from an ultraviolet lamp to determine whether an identification card has been forged/tampered.

In operation 505, according to various embodiments, when the first identity authentication is passed, the financial transaction service provision server 403 may perform remittance function to a first electronic wallet using remittance amount information confirmed from a remittance request. For example, the financial transaction service provision server 403 may check remittance amount information (e.g., X KRW) included in the remittance request, and may purchase cryptocurrency corresponding to currency type information (e.g., A cryptocurrency) specified by the first electronic wallet with an amount corresponding to the remittance amount information and transfer the cryptocurrency to the first electronic wallet. At this time, the remittance amount information may be a total amount deposited by the remittance requestor into the ATM device 401, excluding a remittance fee.

In operation 507, according to various embodiments, when receiving a withdrawal request for the first electronic wallet from the ATM device 401, the financial transaction service provision server 403 may perform second identity authentication for the first electronic wallet. According to one embodiment, the financial transaction service provision server 403 may receive information related to second identity authentication from the ATM device 401 and perform second identity authentication using the received information. For example, when receiving pre-registered card identification information as information related to second identity authentication, the financial transaction service provision server 403 may determine that the second identity authentication has been passed. As another example, when user identification information (e.g., ID, password, mobile phone authentication number, pattern password, etc.) included in the withdrawal request as information related to second identity authentication matches user identification information for the first electronic wallet stored in a memory 130, the financial transaction service provision server 403 may determine that second identity authentication has been passed.

In operation 509, according to various embodiments, when the second identity authentication passes, the financial transaction service provision server 403 may perform withdrawal function through the ATM device 401 using withdrawal amount information confirmed from the withdrawal request. For example, the financial transaction service provision server 403 may confirm withdrawal amount information (e.g., X KRW) included in the withdrawal request, may sell cryptocurrency corresponding to currency type information (e.g., A cryptocurrency) specified by the first electronic wallet with an amount corresponding to the withdrawal amount information, and may transmit, to the ATM device 401, a command to enable withdrawal of an amount corresponding to the withdrawal amount information from the ATM device 401. At this time, the withdrawal amount information may be the total selling amount of the cryptocurrency excluding a withdrawal fec.

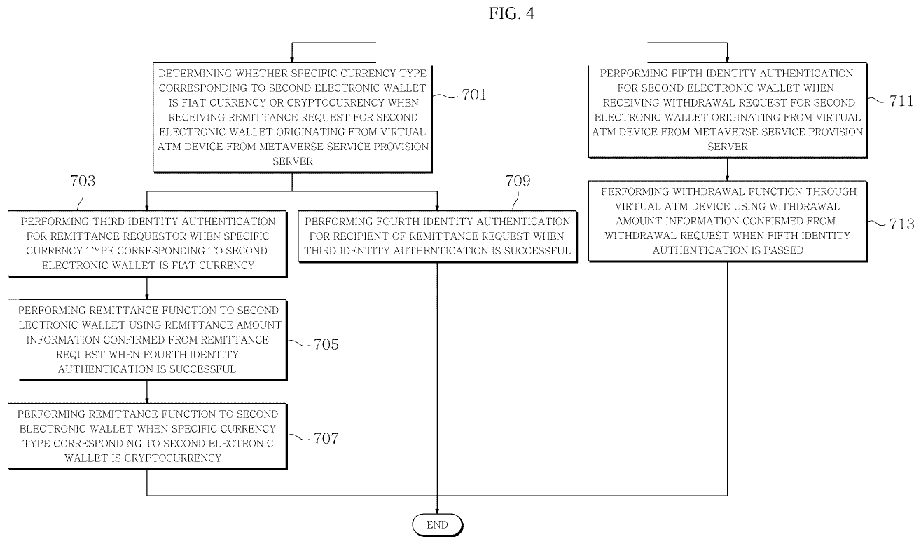

FIG. 4 is a flowchart for explaining the operation of the financial transaction service provision server according to various embodiments (e.g., the financial transaction service provision server 403 of FIG. 1).

In operation 701, according to various embodiments, when receiving a remittance request for a second electronic wallet originating from a virtual ATM device from the metaverse service provision server (e.g., the metaverse service provision server 402 of FIG. 1), the financial transaction service provision server 403 may determine whether the specific currency type corresponding to the second electronic wallet is fiat currency or cryptocurrency. For example, a user may use a virtual ATM device through an avatar in the metaverse environment and may use the virtual ATM device to make electronic financial transactions. At this time, the metaverse service provision server 402 may support electronic financial transactions within the metaverse environment by linking with the financial transaction service provision server 403, which provides electronic wallet services. According to one embodiment, the financial transaction service provision server 403 may check the wallet address of the second electronic wallet included in a remittance request for the second electronic wallet. For example, the financial transaction service provision server 403 may check the wallet address of the second electronic wallet from a QR code included in the remittance request.

According to one embodiment, the financial transaction service provision server 403 may determine whether the specific currency type corresponding to the second electronic wallet is fiat currency or cryptocurrency by analyzing the wallet address of the second electronic wallet. For example, the financial transaction service provision server 403 may analyze a QR code to determine whether the wallet address of the second electronic wallet is a wallet for storing fiat currency or a wallet for storing cryptocurrency. In this case, the financial transaction service provision server 403 may pre-register and store information about the type of each fiat currency, the type of each cryptocurrency, and the type of wallet address for each currency, and may use the information to determine whether the specific currency type corresponding to the second electronic wallet is fiat currency or cryptocurrency.

In operation 703, according to various embodiments, when the specific currency type corresponding to the second electronic wallet is fiat currency, the financial transaction service provision server 403 may perform third identity authentication for the remittance requestor. The third identity authentication may include an operation to check whether the identification information of an avatar used by the remittance requestor in the metaverse environment matches user identification information entered by the remittance requestor. For example, the remittance requestor using an avatar on the metaverse service provision server 402 may register the remittance requestor's identification information (e.g., mobile phone number or resident registration number) when registering the avatar for the first time. When performing third identity authentication, when identification information entered by the remittance requestor is compared with registered identification information, and the entered identification information and the registered identification information match, the financial transaction service provision server 403 may determine that the third identity authentication has been passed.

In operation 705, according to various embodiments, when the third identity authentication is successful, the financial transaction service provision server 403 may perform fourth identity authentication for a recipient of a remittance request. For example, in the case of fiat currency, a wallet address (e.g., bank account number) for storing the fiat currency and the name of a wallet owner may be registered in the financial transaction service provision server 403. The financial transaction service provision server 403 may inquiry with the remittance requestor for information about the recipient of the remittance request (i.e., a person who will receive the remittance) through the metaverse service provision server 402, and may determine that fourth identity authentication is successful, when the information about the recipient obtained from the remittance requestor matches the information about the wallet owner.

In operation 707, according to various embodiments, when the fourth identity authentication is successful, the financial transaction service provision server 403 may perform a remittance function to the second electronic wallet using remittance amount information confirmed from a remittance request. For example, the financial transaction service provision server 403 may check remittance amount information (e.g., K number of A cryptocurrency) included in the remittance request, and may perform remittance to the second electronic wallet by selling an amount corresponding to the remittance amount information in fiat currency corresponding to the currency type information (e.g., B fiat currency) specified by a second electronic wallet.

In operation 709, according to various embodiments, when the specific currency type corresponding to the second electronic wallet is cryptocurrency, the financial transaction service provision server 403 may omit third identity authentication and fourth identity authentication and perform a remittance function to the second electronic wallet. For example, the financial transaction service provision server 403 may check remittance amount information (e.g., K number of A cryptocurrency) included in the remittance request, and may perform remittance to a second electronic wallet by performing currency exchange of an amount corresponding to the remittance amount information in cryptocurrency corresponding to the currency type information (e.g., C cryptocurrency) specified by the second electronic wallet.

In operation 711, according to various embodiments, when receiving a withdrawal request for the second electronic wallet generated from a virtual ATM device from the metaverse service provision server 402, the financial transaction service provision server 403 may perform fifth identity authentication for the second electronic wallet. According to one embodiment, the financial transaction service provision server 403 may receive information related to fifth identity authentication from the metaverse service provision server 402, and may perform fifth identity authentication using the received information. For example, when the user identification information (e.g., ID, password, mobile phone authentication number, pattern password, etc.) of the avatar included in the withdrawal request as information related to fifth identity authentication matches user identification information for the second electronic wallet stored in the memory 130, the financial transaction service provision server 403 may determine that the fifth identity authentication has passed.

In operation 713, according to various embodiments, when the fifth identity authentication is passed, the financial transaction service provision server 403 may perform a withdrawal function through a virtual ATM device using withdrawal amount information confirmed from a withdrawal request. For example, the financial transaction service provision server 403 may check withdrawal amount information (e.g., K number of A cryptocurrency) included in the withdrawal request, may purchase fiat currency corresponding to currency type information (e.g., B fiat currency) specified by the second electronic wallet in an amount corresponding to the withdrawal amount information, and may transmit a command to enable withdrawal of the amount corresponding to the withdrawal amount information from the virtual ATM device to the metaverse service provision server 402 on which the virtual ATM device operates.

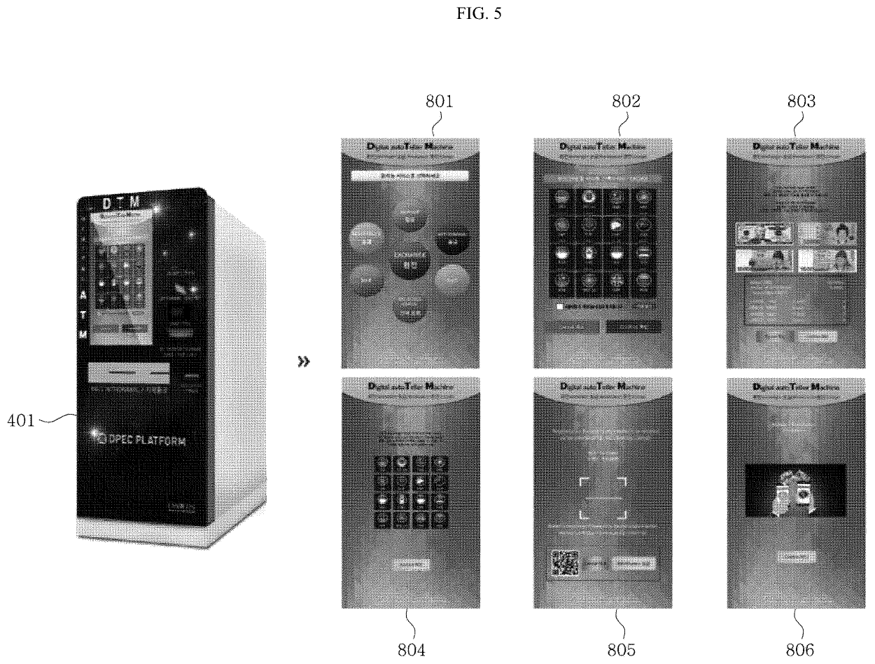

FIG. 5 illustrates the operation of an ATM device (e.g., the ATM device 401 of FIG. 1) according to various embodiments.

According to various embodiments, the ATM device 401 may establish a communication connection with the financial transaction service provision server (e.g., the financial transaction service provision server 403 of FIG. 1), may transmit information for a financial transaction to the financial transaction service provision server 403, may receive the processed results of the information processed by the financial transaction service provision server 403, and may provide various financial transaction services to a user. Referring to <801> of FIG. 5, the ATM device 401 may provide financial services using fiat currency (e.g., remittance, withdrawal, currency exchange, balance inquiry, etc.) and financial services using cryptocurrency (e.g., NFT, Defi, etc.). Referring to <802> of FIG. 5, the ATM device 401 may provide a currency exchange service that receives cash from a user and exchanges the cash into legal currencies of various countries. Referring to <803> of FIG. 5, the ATM device 401 may provide a withdrawal service to withdraw fiat currency or cryptocurrency of other countries as cash. Referring to <804> of FIG. 5, the ATM device 401 may recognize fiat currencies of various countries and provide remittance services for the currencies. Referring to <805> of FIG. 5, the ATM device 401 may transfer deposited cash or remitted currency to other users. The ATM device 401 may provide a remittance service that easily processes remittance by recognizing a QR code at the time of remittance and confirming a recipient's account. Referring to <806> of FIG. 5, when a financial service requested by a user is in progress, the ATM device 401 may provide a user convenience service that displays a screen showing the progress of the service.

According to various embodiments, the ATM device 401 may establish a communication connection with the financial transaction service provision server (e.g., the financial transaction service provision server 403 of FIG. 1), may transmit information for a financial transaction to the financial transaction service provision server 403, may receive the processed results of the information processed by the financial transaction service provision server 403, and may provide various financial transaction services to a user. The ATM device 401 may identify the wallet address of an electronic wallet that performs a financial transaction function (e.g., remittance function) by scanning a QR code displayed on a user device (e.g., smartphone) using a QR code scanner, or may transmit information about the QR code to the financial transaction service provision server 403 so that the financial transaction service provision server 403 analyzes the QR code.

According to one embodiment, after checking the wallet address of an electronic wallet that performs a financial transaction function, the ATM device 401 may display a cryptocurrency selection screen on a display to select the type of cryptocurrency to be transferred to the corresponding electronic wallet. For example, after checking the wallet address of an electronic wallet from a QR code, the ATM device 401 may display, on a display, a cryptocurrency selection screen that may select one of a plurality of types of cryptocurrency supported by the financial transaction service provision server 403, and may receive from a user selection of specific cryptocurrency for a financial transaction (e.g., remittance, recharge, etc.).

The embodiments disclosed in this specification are presented for explanation and understanding of the disclosed technical content, and do not limit the scope of the present invention. Therefore, the scope of the present invention should be interpreted as including all changes or various other embodiments based on the technical idea of the present invention.

1. A system for providing financial transaction services in conjunction with a metaverse environment, comprising:
an automated teller machine (ATM) device;
a metaverse service provision server configured to implement a metaverse environment in which a virtual ATM device operates; and
a financial transaction service provision server that processes functions related to electronic financial services supported by the ATM device and the virtual ATM device and is configured to create an electronic wallet and provide the electronic wallet to a user,
wherein the financial transaction service provision server is configured to 1-1) determine whether a first electronic wallet is linked to the metaverse service provision server when receiving a first remittance request for the first electronic wallet from the ATM device;
1-2) perform first identity authentication using a face image and identification card image of a first remittance requestor when the first electronic wallet is linked to the metaverse service provision server;
1-3) perform a remittance function to the first electronic wallet using remittance amount information confirmed from the first remittance request when the first identity authentication is passed;
2-1) perform second identity authentication for the first electronic wallet when receiving a first withdrawal request for the first electronic wallet from the ATM device; and
2-2) perform a withdrawal function through the ATM device using withdrawal amount information confirmed from the first withdrawal request when the second identity authentication is passed.

2. The system according to claim 1, wherein, when receiving a second remittance request for a second electronic wallet originating from the virtual ATM device from the metaverse service provision server, the financial transaction service provision server is configured to determine whether a specific currency type corresponding to the second electronic wallet is fiat currency or cryptocurrency.

3. The system according to claim 2, wherein the financial transaction service provision server is configured to perform third identity authentication for a second remittance requestor when the specific currency type corresponding to the second electronic wallet is the fiat currency;
perform fourth identity authentication for a recipient of the second remittance request when the third identity authentication is successful; and
perform a remittance function to the second electronic wallet using remittance amount information confirmed from the second remittance request when the fourth identity authentication is successful.

4. The system according to claim 3, wherein, when the specific currency type corresponding to the second electronic wallet is the cryptocurrency, the financial transaction service provision server is configured to omit the third identity authentication and the fourth identity authentication and perform a remittance function to the second electronic wallet.

5. The system according to claim 4, wherein, when receiving a second withdrawal request for the second electronic wallet originating from the virtual ATM device from the metaverse service provision server, the financial transaction service provision server is configured to perform fifth identity authentication for the second electronic wallet.
